(19) United States
(12) Patent Application Publication
(10) Pub. No.: US 2007/0057850 A1
(43) Pub. Date: Mar. 15, 2007

(54) Directional antenna structure

(75) Inventor: Sheng-Hsiung Yang, Hsinchu County (TW)

Correspondence Address: BIRCH STEWART KOLASCH & BIRCH, PO BOX 747, FALLS CHURCH, VA, 22040-0747, US

(73) Assignee: SmartAnt Telecom Co., Ltd.

(21) Appl. No.: 11/513,306

(22) Filed: Aug. 31, 2006

(30) Foreign Application Priority Data
Sep. 9, 2005 (TW) 094215623

(51) Int. Cl. H01Q 1/38

(52) U.S. Cl. 343/700 MS

(57) ABSTRACT

A directional antenna structure is provided, which includes a patch antenna, a reflection plate, a cable connector, and a frame for the patch antenna, the reflection plate, and the cable connector to be fixed and assembled thereon. Through such a modular design, the antenna structure is manufactured and assembled through a simplified process, and besides this advantage, the antenna structure is further selectively integrated with a housing having the same assembly interface, and thus becoming a modular antenna structure integrated with various housings.

### CROSS-REFERENCE TO RELATED APPLICATIONS

This non-provisional application claims priority under 35 U.S.C. § 119(a) on Patent Application No(s). 094215623 filed in Taiwan, R.O.C. on Sep. 9, 2005, the entire contents of which are hereby incorporated by reference.

### BACKGROUND OF THE UTILITY MODEL

1. Field of the Utility Model

The present utility model relates to a directional antenna structure, and more particularly, to an antenna structure with a modular design.

2. Related Art

Antennas have the function of assisting to emit and receive electric waves, which are classified into ultra-long wave, long wave, medium wave, short wave, ultra-short wave, and microwave antennas with the frequency band from low to high. The antennas have been wide applied in national defense and civilian industry. The sizes and lengths of antennas are quite different due to different wave lengths. Antennas can be classified into omni-directional antennas and directional antennas according to their directions.

The directional antenna only faces a specific direction, but has a relative far transmission distance. According to the style and shape, the directional antenna includes patch antennas, panel antennas, yagi antennas and so on, which is generally used to bridge short distances in a wireless local area network. For example, the directional antenna can be used in the environment, such as two buildings respectively located on opposite sides of a street or spacious workshops and storehouses.

A directional patch antenna mainly comprises a patch antenna, a reflection plate, and a cable connector, which are all combined and integrated within a housing. The installation and combination relationship between each part and the housing should be fully considered when designing each style of the antennas, such that the end product can have favorable stability to ensure the quality in use.

Based upon the above, the combination precision of all parts is highly required during the process of designing a product, thereby ensuring the assembling stability.

However, in order to achieve the required assembling stability, the structural design of the conventional antennas is relatively complicated, thereby causing difficulty in assembling the products and a high manufacturing cost.

On the other aspect, consumers quite care about the style of the antenna products when they want to buy one. Therefore, in order to cater to the consumers' requirements, manufacturers exert their efforts to focus on designing the style of the housing when designing the products, which, however, is another factor to increase the manufacturing cost.

### SUMMARY OF THE UTILITY MODEL

Accordingly, in order to solve the problems in assembling and manufacturing cost caused by the complicated structure of the aforementioned directional antennas and designing the style of the housing that is used together with the product, one main object of the present utility model is to provide a design that can be assembled conveniently with an efficiently controlled manufacturing cost.

In order to achieve the above-mentioned object, the present utility model provides a modular design of a directional antenna structure, which comprises a patch antenna, a reflection plate, a cable connector, and a frame, wherein the patch antenna, the reflection plate, and the cable connector can be quickly assembled on the frame, and after other parts have been assembled, the antenna structure is integrated within a housing via the frame.

The frame serves as a bridge to indirectly connect the parts with the housing, thus, not only the means for connecting the parts with the housing are omitted, but also the housing is applicable so long as it satisfies the condition of being integrated with the frame, regardless of the combination relationship with other parts.

Further scope of applicability of the present utility model will become apparent from the detailed description given hereinafter. However, it should be understood that the detailed description and specific examples, while indicating preferred embodiments of the utility model, are given by way of illustration only, since various changes and modifications within the spirit and scope of the utility model will become apparent to those skilled in the art from this detailed description.

### BRIEF DESCRIPTION OF THE DRAWINGS

The present utility model will become more fully understood from the detailed description given herein below for illustration only, which thus is not limitative of the present utility model, and wherein:

FIG. 1 is an exploded stereogram of an antenna structure of the present utility model;

FIG. 2 is a stereogram after the antenna structure of the present utility model has been assembled, which shows a style of a housing that wraps and integrates with the antenna structure;

FIG. 3 is a front view of the assembling state of the antenna structure of the present utility model; and

FIG. 4 is a back view of the assembling state of the antenna structure of the present utility model.

### DETAILED DESCRIPTION OF THE UTILITY MODEL

In order to further understand the technology content and the construction requirements disclosed in the present utility model, the present utility model is illustrated below with reference to the accompanied drawings. However, the accompanying drawings are used for reference and illustration, but not intended to limit the scope of the present utility model.

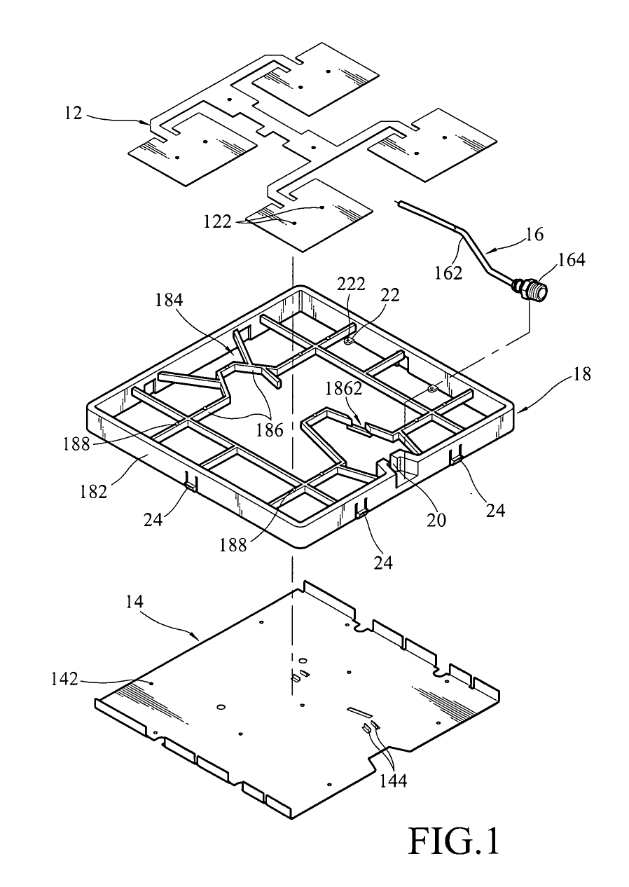

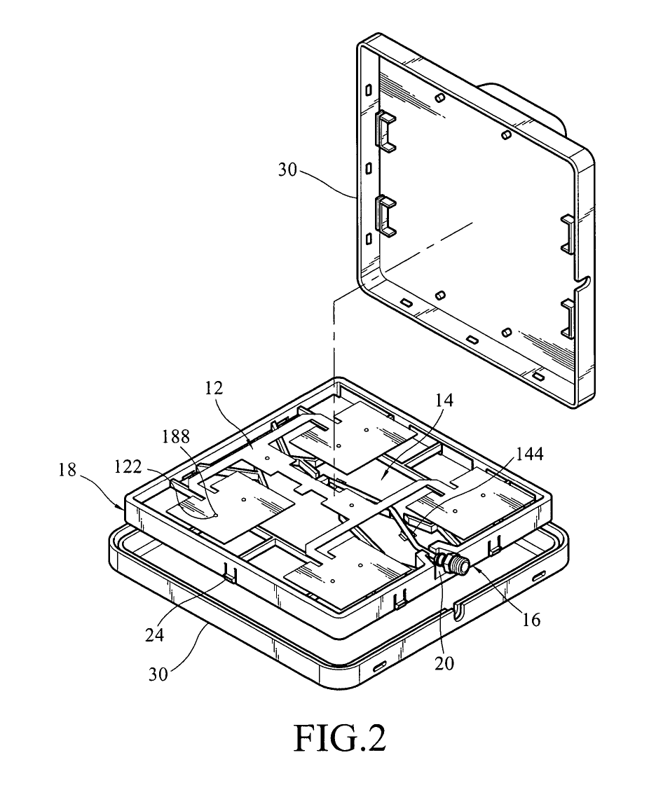

FIG. 1 is an exploded stereogram of an antenna structure, FIG. 2 is a stereogram after the antenna structure disclosed in FIG. 1 has been assembled, which shows a style of a housing that wraps and integrates with the antenna structure. As shown in the figures, the antenna structure comprises a patch antenna 12, a reflection plate 14, a cable connector 16, and a frame 18.

The frame 18 has an outside border 182 and a supporting rib 184 formed within the outside border 182, wherein the supporting rib 184 is formed by a plurality of connected ribs 186 that are connected with each other, and the quantity and connection style of the ribs 186 can be designed and changed depending upon requirements on the structural strength. It is mentioned herein that, the frame 18 is formed by injection molding the plastic material.

Through molding the supporting rib 184 within the outside border 182, the patch antenna 12 and the reflection plate 14 are respectively mounted on two sides of the supporting rib 184, wherein on one side of the supporting rib 184, positioning pillars 188 and positioning holes 122 that are correspondingly snapped with each other are respectively disposed on a part of the ribs 186 and the patch antenna 12; and on the other side of the supporting rib 184, positioning pillars 188 and positioning holes 142 that are correspondingly snapped with each other are respectively disposed on a part of the ribs 186 and the reflection plate 14.

Furthermore, in order to mount the cable connector 16 on the frame 18, a notch 20 is opened in the outside border 182 of the frame 18, such that the cable 162 of the cable connector 16 is embedded into the notch 20 and then snapped and positioned therein.

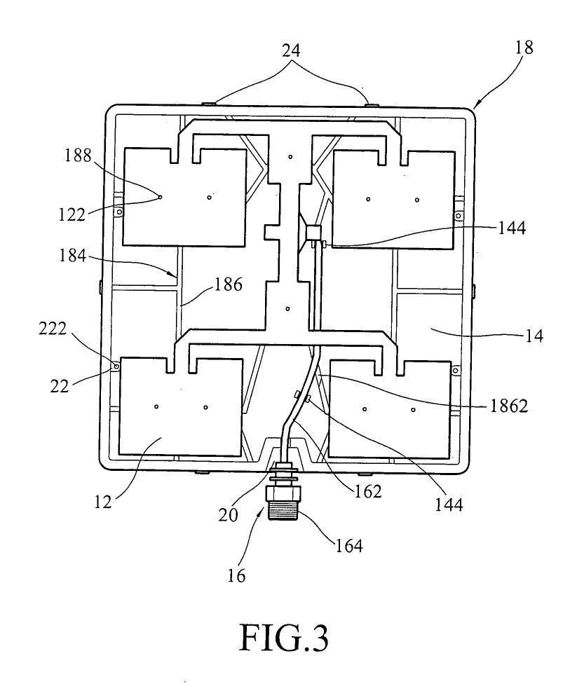

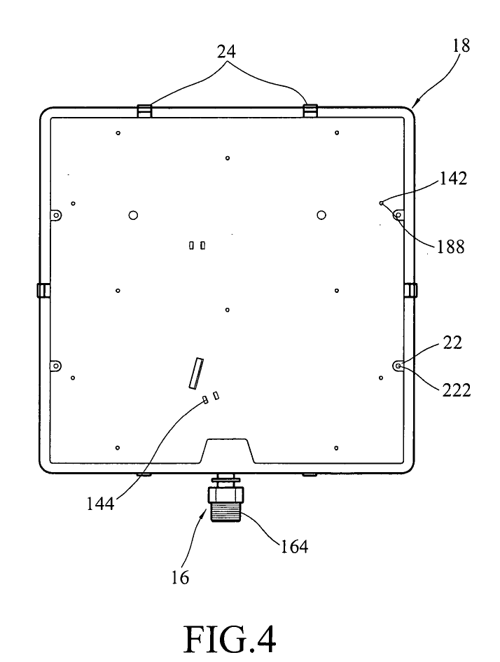

With such a configuration, as shown in FIGS. 3 and 4, the patch antenna 12 and the reflection plate 14 can be mounted on both sides of the frame 18 by way of snapping, and the cable connector 16 can be embedded to the outside border 182 of the frame 18 and thereby being positioned, such that the connector 164 is located outside the frame 18 and the cable 162 is fixed on the reflection plate 14 by way of welding after it has been positioned.

In order to further position the cable 162 of the cable connector 16 to avoid the shaking after it has been installed, fins 144 are pre-disposed on the reflection plate 14 by way of punching and used for the cable 162 of the cable connector 16 to be embedded, thus, the cable 162 is maintained to be positioned under the clamping of the fins 144.

Furthermore, in order to prevent the supporting rib 184 from blocking the cable of the cable connector to force the cable 162 to cross over the ribs 186 and then extrude outwards, as shown in the figures, a fracture 1862 for the cable 162 to pass through is opened on the rib 186 in the predetermined extending path of the cable 162.

In another aspect, the frame 18 itself has an assembly structure for combining with a housing 30, as shown in the figures, for example, a lug 22 is extended on the outside border 182 for disposing a nut hole 222, or more than one fastener 24 is disposed on the outside border 182 for being snapped with the housing 30.

Of course, a binary assembly structure with both the nut holes 222 and the fasteners 24 can be formed on the frame 18, so long as the housing 30 itself also has corresponding configurations to be matched with both the nut holes 222 and the fasteners 24 of the binary assembly structure.

To sum up, the antenna structure provided by the present utility model utilizes the frame as a bridge to indirectly connect the other parts with the housing, thus, not only the means for connecting the parts with the housing are omitted, but also the housing is applicable, so long as it satisfies the condition to be integrated with the frame, regardless of the combination relationship with other parts.

Compared with the conventional antennas, the antenna structure of the present utility model is not only assembled conveniently, but also has a design with an efficiently controlled manufacturing cost.

The present utility model being thus described, it will be obvious that the same may be varied in many ways. Such variations are not to be regarded as a departure from the spirit and scope of the present utility model, and all such modifications as would be obvious to one skilled in the art are intended to be included within the scope of the following claims.

What is claimed is:

1. A directional antenna structure, used for being assembled within a housing, comprising:
a patch antenna;
a reflection plate;
a cable connector, wherein a cable is connected to the reflection plate; and
a frame, having an outside border and a supporting rib formed within the outside border, wherein the patch antenna and the reflection plate are positioned on two sides of the supporting rib and then integrated with each other, and a notch is further opened in the outside border for the cable of the cable connector to be embedded therein.

2. The directional antenna structure as claimed in claim 1, wherein the supporting rib of the frame and the plate antenna are respectively provided with positioning pillars and positioning holes that are correspondingly snapped with each other.

3. The directional antenna structure as claimed in claim 1, wherein the supporting rib of the frame and the reflection plate are respectively provided with positioning pillars and positioning holes that are correspondingly snapped with each other.

4. The directional antenna structure as claimed in claim 1, wherein more than one nut hole is opened in the outside border of the frame for locking with the housing.

5. The directional antenna structure as claimed in claim 4, wherein the nut hole is formed in a lug extending from the outside border.

6. The directional antenna structure as claimed in claim 1, wherein more than one fastener is disposed on the outside border of the frame for snapping with the housing.

7. The directional antenna structure as claimed in claim 1, wherein fins are disposed on the reflection plate by way of punching and used for the cable of the cable connector to be embedded.

8. The directional antenna structure as claimed in claim 1, wherein the supporting rib is formed by connecting a plurality of ribs, and a fracture is opened in the rib for the cable of the cable connector to pass through.
